(19) United States
(12) Patent Application Publication
(10) Pub. No.: US 2013/0201693 A1
(43) Pub. Date: Aug. 8, 2013

(54) ANTI-GLARE LENS

(71) Applicant: Te-Lung TANG, New Taipei City (TW)

(72) Inventor: Te-Lung TANG, New Taipei City (TW)

(21) Appl. No.: 13/367,400

(22) Filed: Feb. 7, 2012

(51) Int. Cl. F21V 5/04

(52) U.S. Cl. 362/335

(57) ABSTRACT

An anti-glare lens assembly includes a lens and a frame. The lens includes a lens portion and a mounting portion coupled to a circumference of the lens portion. The frame includes a sidewall structure coupled to the lens and a hollow cavity that is surrounded by the sidewall structure to expose the lens portion. The sidewall structure has a wall surface on which at least one anti-glare region is formed. The sidewall structure is provided with a counterpart mounting portion mating the mounting portion in order to couple the frame and the lens together so that when light passes through the lens portion, a portion of the light that is reflected outward by a circumferential portion of the lens portion is homogenized by the anti-glare region to thereby reduce occurrence of glare caused by secondary refraction of the light.

### FIELD OF THE INVENTION

The present invention relates to an anti-glare lens, and in particular to an anti-glare lens that is mountable in a lighting device to reduce the occurrence of glare, reduce interference with visual perception, and overcome easy visual fatigue.

### BACKGROUND OF THE INVENTION

A conventional lighting device is generally composed of a number of light supplying components, including a light source (such as a light bulb, a lighting panel, or a structure comprising light-emitting diodes) and a convex lens. The convex lens as a surface that is planar and an opposite surface that is convex. The convex lens is oriented with the planar surface facing the light source in order to condense the light emitting from the light source and to project the light outward. Further, to conduct off the thermal energy generated by long term illumination of the light source, the light source and the convex lens are together placed in a heat dissipation structure made of metallic materials.

However, besides the light that is directly emitted from the light source, a fraction of the light is projected from a circumference of the convex lens, and those lights induce secondary reflection on the metal surface of the heat dissipation structure, making the eyes of users irritated and causing interference with the visual perception of the users, and eventually leading to discomfort and easy visual fatigue.

In view of these problems, the present invention aims to provide an anti-glare lens that is resistant to glare and light leakage and homogenizes the leaking light so as to reduce the occurrence of glare, reduce undesired interference with visual perception, and overcome easy visual fatigue.

### SUMMARY OF THE INVENTION

An objective of the present invention is to provide an anti-glare lens that is resistant to glare and light leakage and homogenizes the leaking light so as to reduce the occurrence of glare, reduce undesired interference with visual perception, and overcome easy visual fatigue.

To realize the above objectives, the present invention provides an anti-glare lens, which comprises: a lens, which comprises a lens portion and a mounting portion coupled to a circumference of the lens portion; and a frame, which comprises a sidewall structure coupled to the lens and a hollow cavity that is surrounded by the sidewall structure to expose the lens portion. The sidewall structure has a wall surface on which at least one anti-glare region is formed. The sidewall structure is provided with a counterpart mounting portion mating and coupleable to the mounting portion in order to couple the frame and the lens together so that when light passes through the lens portion, a portion of the light that is reflected outward by a circumferential portion of the lens portion is homogenized by the anti-glare region to thereby reduce occurrence of glare caused by secondary refraction of the light. As such, effects of glare resistance, light leakage resistance, and homogenization of leaking light can be realized to reduce the occurrence of glare, reduce the undesired interference with visual perception, and overcome easy visual fatigue.

### BRIEF DESCRIPTION OF THE DRAWINGS

The present invention will be apparent to those skilled in the art by reading the following description of preferred embodiments thereof with reference to the drawings, in which:

FIG. 1 is a cross-sectional view of an anti-glare lens assembly according to the present invention;

FIG. 2 is a schematic view illustrating an inner wall surface of a sidewall structure of FIG. 1 being made inclined;

FIG. 3 is a cross-sectional view illustrating a sidewall structure of the anti-glare lens assembly according to the present invention being made in an inclined form;

FIG. 4 is a cross-sectional view illustrating a sidewall structure of the anti-glare lens assembly of the present invention being made in a convex form, and an extension section being provided in the form of a horizontally extending structure;

FIG. 5 is a cross-sectional view illustrating an extension section according to the present invention being made in an inclined extension structure;

FIG. 6 is a cross-sectional view illustrating the extension section of FIG. 5 being modified as a vertically extending structure;

FIG. 7 is a cross-sectional view illustrating the sidewall structure of FIG. 6 being modified as a concave form, the extension section being made in a curved extension structure;

FIG. 8 is a cross-sectional view illustrating the sidewall structure of FIG. 7 being modified as a vertical form;

FIG. 9 is a perspective view showing an unitary configuration of which a lens and a frame are integrally formed together; and

FIG. 10 is a cross-sectional view of FIG. 9.

### DETAILED DESCRIPTION OF THE PREFERRED EMBODIMENTS

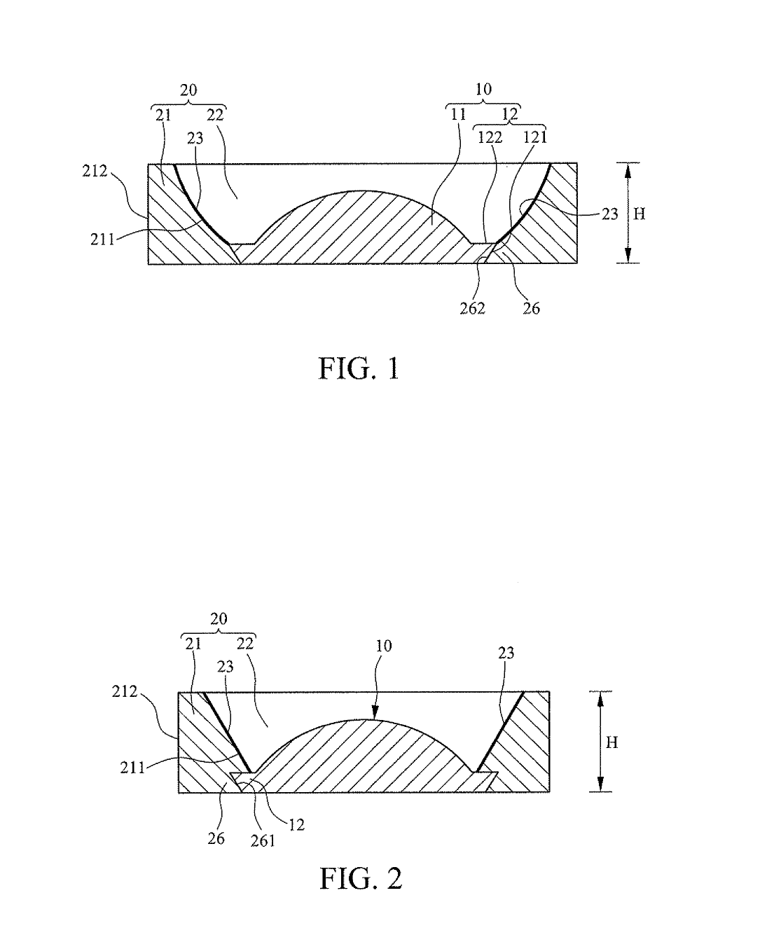

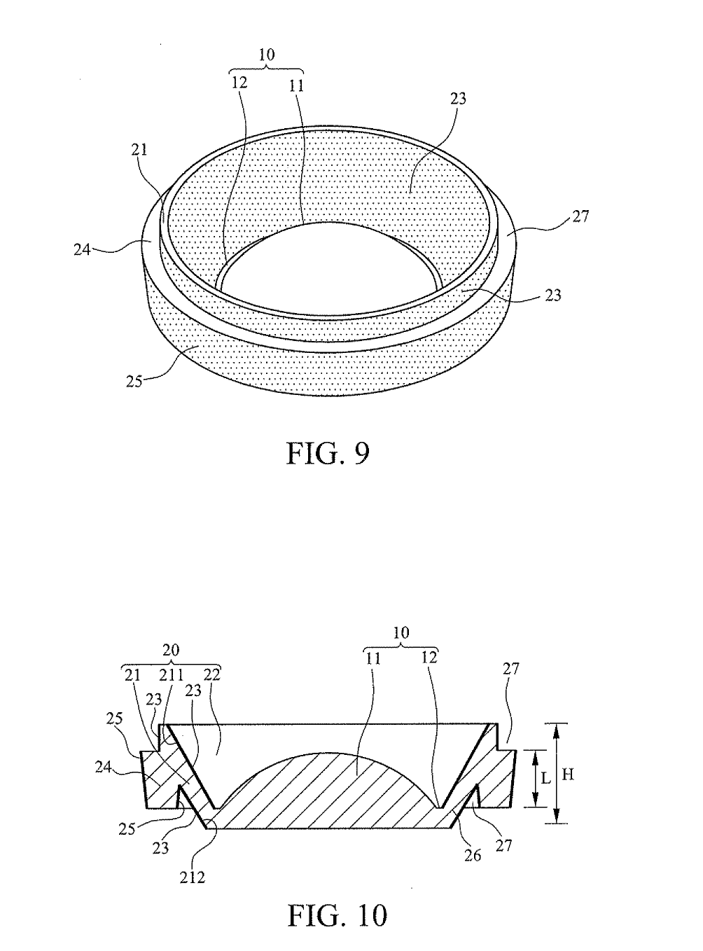

With reference to the drawings and in particular to FIGS. 1-10, the present invention provides an anti-glare lens assembly, which comprises a lens 10 and a frame 20. The lens 10 comprises a lens portion 11 and a mounting portion 12 that is coupled to a circumference of the lens portion 11. The frame 20 comprises a sidewall structure 21 coupled to the lens 10 and a hollow cavity 22 that is surrounded by the sidewall structure 21 to expose the lens portion 11. The sidewall structure 22 has a wall surface on which at least one anti-glare region 23 is formed. The sidewall structure 21 is provided with a counterpart mounting portion 26 that mates and is coupleable to the mounting portion 12 in order to couple the frame 20 and the lens 10 together so that when light passes through the lens portion 11 of the present invention, the portion of the light that is reflected outward by a circumferential portion of the lens portion 11 is homogenized by the anti-glare region 23 of the sidewall structure 22, thereby reducing the occurrence of glare caused by secondary refraction of light and thus reducing undesired interference with visual perception caused by the glare and overcoming easy visual fatigue.

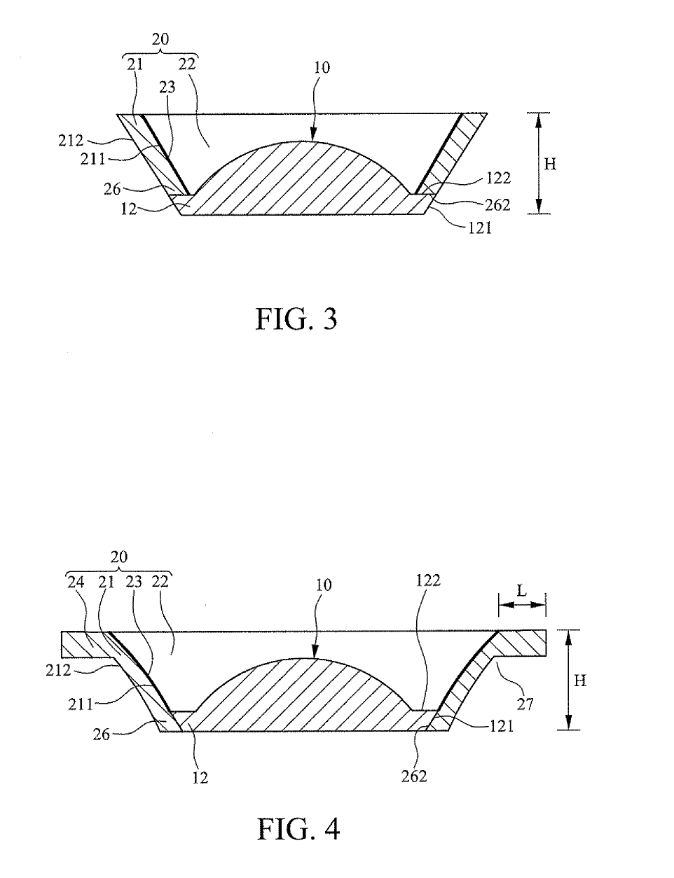

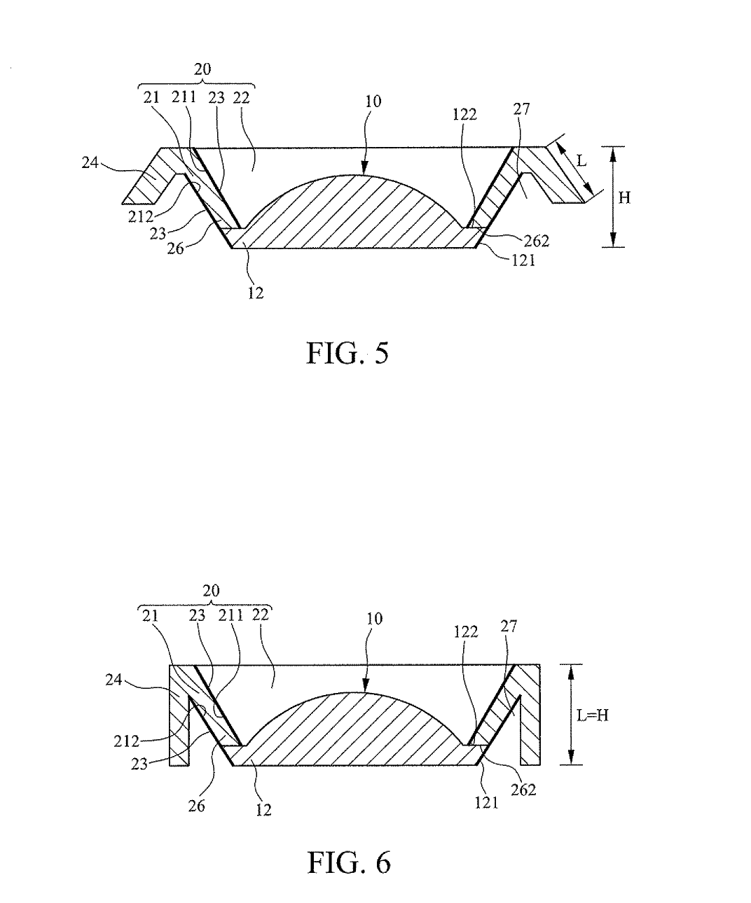

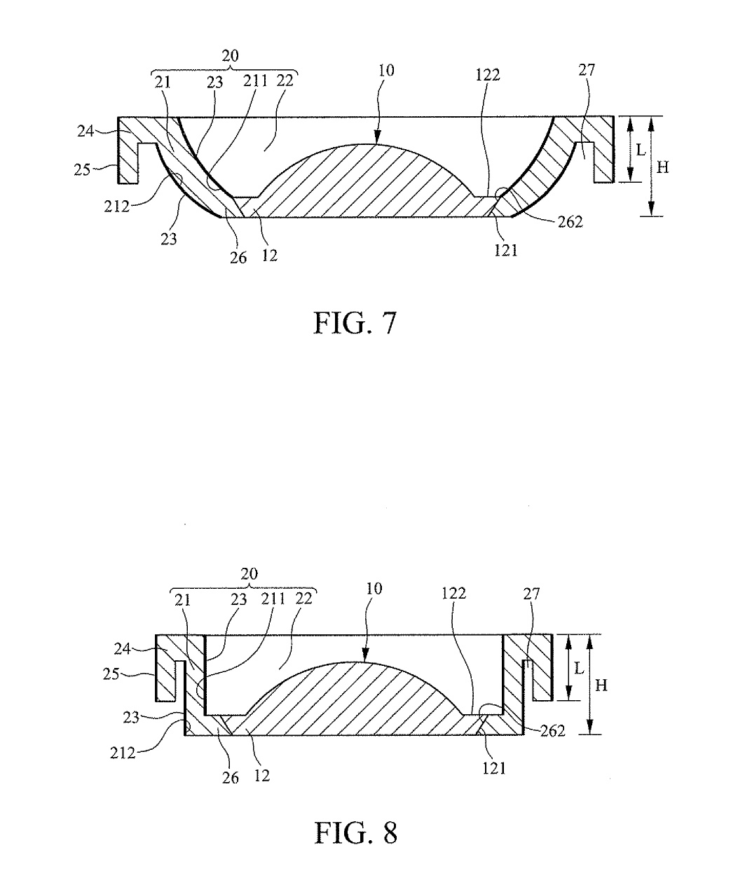

In an embodiment, the sidewall structure 21 comprises an inner wall surface 211 and an outer wall surface 212 corresponding to each other. The inner wall surface 211 can be inclined (such as the inner wall surface 211 illustrated in FIGS. 2, 3, 5, 6, and 10), vertical (as shown in FIG. 8), curved, convex (as shown in FIG. 4), or concave (such as the inner wall surface 211 illustrated in FIGS. 1 and 7). The outer wall surface 212 can be inclined (such as the outer wall surface 212 illustrated in FIGS. 3, 5, 6, and 10), vertical (such as the outer wall surface 212 illustrated in FIGS. 1, 2, and 8), curved, convex (as shown in FIG. 4), or concave (as shown in FIG. 7). Through combinations of identically-shaped or differently-shaped inner wall surface 211 and outer wall surface 212, numbers of available embodiments of the sidewall structure 21 can be increased to allow the shape of the sidewall structure 21 to be for example a convergent form (such as the sidewall structure 21 illustrated in FIGS. 1 and 2), an inclined form (such as the sidewall structure 21 illustrated in FIGS. 3, 5, 6, and 10), a vertical form (as shown in FIG. 8), a curved form (such as the sidewall structure 21 illustrated in FIGS. 4 and 7) or a deflected form. The position where the anti-glare region 23 is set can be varied as desired according to practical needs, for example being arranged only on the inner wall surface 211 (such as the anti-glare region 23 illustrated in FIGS. 1-4), or being arranged only on the outer wall surface 212 in order to reduce the processing operations, or alternatively it is possible to arranged anti-glare regions 23 on both the inner wall surface 211 and the outer wall surface 212 (such as the anti-glare regions 23 illustrated in FIGS. 5-8 and 10) to provide an effect of doubled homogenization and refraction of light for reducing the occurrence of glare and light leakage.

Referring to FIGS. 4-10, the frame 20 is further provided with an extension section 24, which facilitates mounting to an external object (such as engaging and fixing to a lamp hood or a lighting pane). Further, the extension section 24 is formed by extending from an end rim of the sidewall structure 21 (for example, extending from a top end rim of the sidewall structure 21, as shown in FIG. 4), whereby the extension section 24 and the sidewall structure 21 collectively define therebetween a retention slot 27, by which the frame 20 of the anti-glare lens assembly can be for example mounted to a surface of a lighting device (not shown); alternatively, the extension section can extend from a predetermined portion of the sidewall structure 21 (such as the outer wall surface 212, and being illustrated to extend from one third location of height of the sidewall structure 21 in FIG. 10), so that the extension section 24 and the sidewall structure 21 collectively form therebetween two retention slots 27, by which an outer casing (not shown) can be readily mounted on the frame 20 for the purposes of protecting the anti-glare lens assembly of the present invention mounted to the lighting device (not shown) and making the outside appearance flat and good looking.

To increase the number of available configurations of the retention slot 27, which in turn increases the number of available mounting that the frame 20 can be made, the extension section 24 shows an extension length L. Also, the anti-glare lens assembly of the present invention shows a height H. The extension length L of the extension section 24 may has a minimum value that is shorter than the height H of the anti-glare lens assembly; alternatively, the extension length L may be made equal to the height H of the anti-glare lens assembly, or the extension length L may have a maximum value that exceeds the height H of the anti-glare lens assembly.

In addition, the extension section 24 can be made as a horizontally extending structure (as shown in FIG. 4), a vertically extending structure (such as the extension section 24 illustrated in FIGS. 6 and 10), an inclined extension structure (as shown in FIG. 5), or a curved extension structure (such as the extension section 24 illustrated in FIGS. 7 and 8). Further, the extension section 24 can be made gradually reducing from the connection thereof with the sidewall structure 21 toward an opposite end of the extension section 24 (as shown in FIG. 10). Based on the lighting device (not shown) to which the present invention is embodied, the retention slot 27 can be formed in a corresponding configuration to facilitate easy mounting of the frame 20, facilitate application to external objects of different types and sizes, and improve convenience of use. The external objects mentioned here can be for example components of lighting fixtures, such as a bulb socket, a lighting panel seat, a socket structure comprising light-emitting diodes, and a hood, which are commonly available in the market.

Further, referring to FIGS. 7-10, the extension section 24 has a surface that is provided with at least one secondary anti-glare region 25 The secondary anti-glare region 25 can be arranged on only one surface of the extension section 24 (such as the secondary anti-glare region 25 illustrated in FIGS. 7 and 8) or on both surfaces of the extension section 24 (as shown in FIG. 10), whereby with the arrangement of the anti-glare region 23 and the secondary anti-glare region 25, homogenization of refracted light can be realized in multiple times to improve the effect of resisting glare and light leakage and also show an aesthetic result.

To match the configuration of the sidewall structure 21, the anti-glare region 23 and the secondary anti-glare region 25 can be embodied in various ways, including a surface of the sidewall structure 21 being composed of a partially textured region, a completely textured region, a partially coated region, or a completely coated region. The coated region generally comprises for example a coating of dark color (such as black) that absorbs light.

Further, the lens 10 and the frame 20 of the present invention can be manufactured separately or integrally. When the connection between the counterpart mounting portion 26 of the frame 20 and the mounting portion 12 of the lens 10 is to be made movable, the lens 10 and the frame 20 are manufactured separately and then connected to each other with ultrasonic welding treatment or application of a bonding agent. The anti-glare region 23 can be positioned on the mounting portion 12 of the lens 10 according to a practical form of connection (for example the anti-glare region 23 being connected to extend from the outer wall surface 212 to the underside outer circumference of the mounting portion 12 as shown in FIG. 6) to improve the effect of resisting light leakage. If the connection between the counterpart mounting portion 26 and the mounting portion 12 is made solidly fixed (as shown in FIG. 10), then the lens 10 and the frame 20 can be integrally formed as an unitary member. Further, the lens portion 11 can be in the form of a convex lens, a plane-convex lens, a Fresnel lens, or other forms of lens showing an equivalent effect.

To allow the connection between the mounting portion 12 and the counterpart mounting portion 26 to match various forms of sidewall structure 21, the mounting portion 12 can be of a flange structure, which has an outer circumferential surface forming a slope face 121 and a level face 122 is arranged closely adjacent to the slope face 121 to couple the counterpart mounting portion 26. Based on the form of the sidewall structure 21, the counterpart mounting portion 26 can be in the form of a recess 261 or a counterpart slope face 262. When the counterpart mounting portion 26 forms a recess 261 (as shown in FIG. 2), the entire flange structure (the mounting portion 12) can be fitted therein for coupling. When the counterpart mounting portion 26 forms a counterpart slope face 262, the counterpart slope face 262 is formed on the inner wall surface 211 of the sidewall structure 21 (such as the counterpart slope face 262 shown in FIGS. 1, 4, 7, and 8) in order to mate and couple the slope face 121 of the mounting portion 12. Alternatively, the counterpart slope face 262 is formed on a bottom end of the sidewall structure 21 (such as the counterpart slope face 262 shown in FIGS. 3, 5, and 6) to mate and couple the level face 122 of the mounting portion 12.

As such, the present invention provides an anti-glare lens assembly that is formed of a combination of a lens 10 and a frame 20 so as to provide an effect of glare resistance, light leakage resistance, and homogenization of leaking light thereby reducing the occurrence of glare, reducing undesired interference with visual perception, and overcoming easy visual fatigue.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An anti-glare lens assembly, comprising:
a lens, which comprises a lens portion and a mounting portion coupled to a circumference of the lens portion; and
a frame, which comprises a sidewall structure coupled to the lens and a hollow cavity that is surrounded by the sidewall structure to expose the lens portion, the sidewall structure having a wall surface on which at least one anti-glare region is formed; the sidewall structure being provided with a counterpart mounting portion mating and coupleable to the mounting portion in order to couple the frame and the lens together so that when light passes through the lens portion, a portion of the light that is reflected outward by a circumferential portion of the lens portion is homogenized by the anti-glare region to thereby reduce occurrence of glare caused by secondary refraction of the light.

2. The anti-glare lens assembly as claimed in claim 1, wherein the sidewall structure of the frame comprises an inner wall surface and an outer wall surface corresponding to each other, the sidewall structure having a shape that is selectively one of a convergent form, an inclined form, a vertical form, and a curved form, the anti-glare region being selectively arranged on the inner wall surface, on the outer wall surface, on both the inner wall surface and the outer wall surface, the inner wall surface being selectively one of an inclined form, a vertical form, a curved form, a convex form, and a concave form, the outer wall surface being selectively one of an inclined form, a vertical form, a curved form, a convex form, and a concave form.

3. The anti-glare lens assembly as claimed in claim 2, wherein the sidewall structure of the frame comprises an extension section, the extension section being selectively one of a horizontally extending structure), a vertically extending structure, an inclined extension structure, and a curved extension structure, the extension section having a surface that is provided with at least one secondary anti-glare region, the secondary anti-glare region being selectively arranged on one surface of the extension section or arranged on two relative surfaces of the extension section.

4. The anti-glare lens assembly as claimed in claim 3, wherein the extension section extends from one of an end rim of the sidewall structure and the outer wall surface, whereby the extension section and the sidewall structure collectively define therebetween at least one retention slot, the extension section having an extension length, the anti-glare lens assembly having a height, the extension length being selectively smaller than, equal to, or greater than the height for mounting the frame of the anti-glare lens assembly.

5. The anti-glare lens assembly as claimed in claim 4, wherein the extension section is gradually reducing from connection thereof with the sidewall structure toward an opposite end of the extension section.

6. The anti-glare lens assembly as claimed in claim 3, wherein the anti-glare region and the secondary anti-glare region are selectively partially textured, completely textured, partially coated, or completely coated.

7. The anti-glare lens assembly as claimed in claim 1, wherein the sidewall structure of the frame comprises an extension section, the extension section being selectively one of a horizontally extending structure), a vertically extending structure, an inclined extension structure, and a curved extension structure, the extension section having a surface that is provided with at least one secondary anti-glare region, the secondary anti-glare region being selectively arranged on one surface of the extension section or arranged on two relative surfaces of the extension section.

8. The anti-glare lens assembly as claimed in claim 7, wherein the extension section extends from one of an end rim of the sidewall structure and the outer wall surface, whereby the extension section and the sidewall structure collectively define therebetween at least one retention slot, the extension section having an extension length, the anti-glare lens assembly having a height, the extension length being selectively smaller than, equal to, or greater than the height for mounting the frame of the anti-glare lens assembly.

9. The anti-glare lens assembly as claimed in claim 8, wherein the extension section is gradually reducing from connection thereof with the sidewall structure toward an opposite end of the extension section.

10. The anti-glare lens assembly as claimed in claim 7, wherein the anti-glare region and the secondary anti-glare region are selectively partially textured, completely textured, partially coated, or completely coated.

11. The anti-glare lens assembly as claimed in claim 1, wherein the counterpart mounting portion and the mounting portion are connected in either a movable form or a fixed form, the lens portion being one of a convex lens, a plano-convex lens, and a Fresnel lens.

12. The anti-glare lens assembly as claimed in claim 11, wherein the mounting portion is of a flange structure, which has an outer circumferential surface forming a slope face, a level face being arranged adjacent to the slope face to couple the counterpart mounting portion, the counterpart mounting portion selectively forming one of a recess and a counterpart slope face for coupling the mounting portion.

13. The anti-glare lens assembly as claimed in claim 1, wherein the mounting portion is of a flange structure, which has an outer circumferential surface forming a slope face, a level face being arranged adjacent to the slope face to couple the counterpart mounting portion, the counterpart mounting portion selectively forming one of a recess and a counterpart slope face for coupling the mounting portion.
